(19) United States
(12) Patent Application Publication
(10) Pub. No.: US 2025/0298491 A1
(43) Pub. Date: Sep. 25, 2025

(54) Visually Distinguishing Selectable Objects Depicted in an Image

(71) Applicant: Google LLC, Mountain View, CA (US)

(72) Inventors: Kankan Meng, Bellevue, WA (US); Sabrina Marie Curry, Oakland, CA (US); Morgane Magali Laure Sanglier, San Francisco, CA (US)

(21) Appl. No.: 19/003,845

(22) Filed: Dec. 27, 2024

Related U.S. Application Data
(60) Provisional application No. 63/616,403, filed on Dec. 29, 2023.

(51) Int. Cl. G06F 3/04817; G06T 7/13

(52) U.S. Cl. CPC G06F 3/04817; G06T 7/13

(57) ABSTRACT

An image comprising a plurality of pixels is accessed. An object boundary of an object depicted in the image is determined. The image is provided for display. During a shimmer phase, pixel values of pixels within the object boundary are altered to introduce visual noise into the pixels of the image within the object boundary for a shimmer phase period of time. A user selectable icon is provided for display in association with the object depicted in the image.

### RELATED APPLICATIONS

This application claims priority to and the benefit of U.S. Provisional Patent Application No. 63/616,403, filed Dec. 29, 2023. U.S. Provisional Patent Application No. 63/616,403 is hereby incorporated by reference in its entirety.

### FIELD

The present disclosure is directed generally to the field of computer vision, and more specifically to mechanisms for identifying and visually distinguishing selectable objects depicted in an image.

### BACKGROUND

Search engines and other digital tools such as browser applications have made it easier for users to find images relevant to their interests or information needs. However, while search engines or other digital tools are generally effective at returning images that align with the user's search query or interests, they can often fail to provide intuitive ways for users to interact with the objects depicted within these images.

For example, a user may perform a search for home décor ideas and be presented with an image that depicts a beautifully decorated room. While the user can view the image, they may be interested in obtaining further information about specific objects within that image, such as a couch, a table lamp, or a decorative rug. Currently, it is not intuitive for the user to understand which objects within the image are selectable for obtaining further information, and which are not. This lack of intuitive interaction can lead to user confusion and inefficient navigation, as the user may need to perform multiple different searches or unnecessary selections to find the object of interest, each of which consumes computational resources.

Additionally, an image may contain multiple overlapping objects which can make it even more challenging for the user to identify and select a specific object for further information. The problem is further exacerbated when the selectable objects are not visually distinguished from the non-selectable objects. Therefore, there is a need for a system that can visually distinguish selectable objects in a digital image to enhance the user's interaction and experience. This need is a technical problem as it necessitates a solution that involves technical considerations in the fields of computer vision, image processing, and user interface design.

### SUMMARY

Aspects and advantages of embodiments of the present disclosure will be set forth in part in the following description, or can be learned from the description, or can be learned through practice of the embodiments.

In one implementation a method is provided. The method includes accessing, by a computing system comprising one or more computing devices, an image comprising a plurality of pixels. The method further includes determining, by the computing system, an object boundary of an object depicted in the image. The method further includes providing for display, by the computing system, the image. The method further includes altering, by the computing system, during a shimmer phase, pixel values of pixels within the object boundary to introduce visual noise into the pixels of the image within the object boundary for a shimmer phase period of time. The method further includes providing for display, by the computing system, a user selectable icon in association with the object depicted in the image.

In another implementation a computing system is provided. The computing system includes one or more computing devices operable to access an image comprising a plurality of pixels. The one or more computing devices are further operable to determine an object boundary of an object depicted in the image. The one or more computing devices are further operable to provide the image for display. The one or more computing devices are further operable to alter, during a shimmer phase, pixel values of pixels of the image within the object boundary to introduce visual noise into the pixels within the object boundary for a shimmer phase period of time. The one or more computing devices are further operable to provide for display a user selectable icon in association with the object depicted in the image.

In another implementation a non-transitory computer-readable storage medium is provided. The non-transitory computer-readable storage medium includes executable instructions operable to cause one or more computing devices to access an image comprising a plurality of pixels. The executable instructions are further operable to cause the one or more computing devices to determine an object boundary of an object depicted in the image. The executable instructions are further operable to cause the one or more computing devices to provide the image for display. The executable instructions are further operable to cause the one or more computing devices to alter, during a shimmer phase, pixel values of pixels of the image within the object boundary to introduce visual noise into the pixels within the object boundary for a shimmer phase period of time. The executable instructions are further operable to cause the one or more computing devices to provide for display a user selectable icon in association with the object depicted in the image.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIGS. 1A-1F illustrate a block diagram of an environment at different points in time in which visually distinguishing selectable objects in an image can be practiced according to some implementations;

FIG. 2 depicts a flow chart diagram of an example method to visually distinguish selectable objects in an image according to example embodiments of the present disclosure;

FIGS. 3A-3N illustrate a block diagram of an environment at different points in time in which visually distinguishing selectable objects in an image can be practiced according to additional implementations;

FIGS. 4A-4F illustrate a block diagram of an environment at different points in 0time in which visually distinguishing selectable objects in an image can be practiced according to additional implementations; and

FIG. 5 depicts a block diagram of a computing system that implements visually distinguishing selectable objects in an image according to example embodiments of the present disclosure.

Reference numerals that are repeated across plural figures are intended to identify the same features in various implementations.

### DETAILED DESCRIPTION

The present disclosure and the examples provided herein relate to systems and methods for visually distinguishing selectable objects in an image. Leveraging advanced computer vision and image processing techniques, this technology enhances user interaction with digital images and addresses the common issue wherein users struggle to understand which objects within an image are selectable for obtaining further information. This issue is particularly relevant in the context of search engines, where users may receive multiple search result images depicting one or more objects in response to a query comprising one or more search terms.

Specifically, example implementations of the present disclosure include the use of a computing system to access an image made up of multiple pixels, which could be obtained from various sources such as a digital camera, a scanned document, a web document (e.g., “web page”), an image database, or as a result of a search engine query (e.g., an “image search” result).

As one example, a search engine may, in response to a query comprising one or more search terms, return one or more search result images. The search result images may depict one or more objects. The search engine may implement a feature where certain of the objects depicted in a search result image can be selected by a user to obtain more information about the object. For example, upon the selection of an object the search engine may present information about the object, or may automatically initiate an additional search based on characteristics of the object.

However, an image may depict multiple objects, many of which may overlap one another. For example, an image may depict a couch that includes a decorative pillow laying on top of a blanket that is resting on a portion of the couch. Even if the user who entered the search query is aware that one or more objects depicted in the image may be selectable to cause some additional action to occur, such as the presentation of information about the object or the initiation of an additional search, it may not be intuitive to the user which objects are selectable. To provide an example, an image may depict a person or multiple persons wearing multiple different garments or other items (e.g., a shirt, a coat, pants, a necklace, a hat, etc.). However, a user attempting to interact with (e.g., conduct a supplemental search for) one of the different garments depicted in the image may have difficulty understanding which, if any, of the specific garments can be interacted with to obtain additional search results.

As a solution to this challenge, example implementations of the present disclosure determines the object boundary of one or more objects depicted in the image. This step allows the system to identify which parts of the image contain objects of interest (e.g., objects for which additional search results may be available). This process could involve various computer vision techniques, such as edge detection, image segmentation, or machine learning algorithms trained to recognize specific objects.

Upon determining the object boundary, the image can be displayed on a suitable device, such as a computer monitor, a smartphone screen, or a virtual reality headset. At this point, the computing system may enter the image into a “shimmer phase”. During this phase, the pixel values of the pixels within the object boundary are altered to introduce visual noise. This visual noise, or “shimmer pattern” as it can sometimes be referred to, effectively distinguishes the selectable objects from the rest of the image. This feature is particularly useful in images where multiple objects, many of which may overlap one another, are depicted.

In some implementations, the shimmer phase is not permanent and lasts for a specific period of time to catch the user's attention. For example, once the shimmer phase ends, the original pixel values are restored, ensuring that the visual noise does not permanently alter the image and allowing the user to continue interacting with the image in its original form.

Moreover, some example implementations can further provide, after the “shimmer phase” completes, a user-selectable icon in association with the object depicted in the image, serving as an additional visual cue that the object is selectable. In some implementations, the technology also includes a preliminary shimmer phase before the main shimmer phase to prepare the user or provide additional visual distinction for the selectable objects.

In addition, some implementations of the present disclosure allow for the determination of multiple object boundaries within an image, meaning that multiple objects within an image can be visually distinguished and made selectable. This feature could be particularly useful in complex images where multiple objects of interest are present.

Thus, example systems and methods disclosed herein implement mechanisms for visually distinguishing selectable objects in an image. In some implementations, a pattern (sometimes referred to herein as a “shimmer” or a “shimmer pattern”) is applied to selectable objects depicted within an image for a relatively brief period of time to visually distinguish such objects from objects depicted in the image that are not selectable. The application of the pattern to the selectable objects highlights to the user, in an intuitive manner, those objects in the image that are selectable.

Aspects of the present disclosure provide technical effects which pertain to the field of computer vision and image processing, specifically focusing on the identification and visual distinction of selectable objects within digital images. The technical solutions include the accessing and processing of digital images composed of multiple pixels, the determination of object boundaries within these images, and the alteration of pixel values to visually distinguish the selectable objects.

Example implementations of the present disclosure include the use a variety of technical tools to achieve its desired outcomes. For example, a computing system can access and process digital images to determine object boundaries within the images, which is a technical task that requires advanced image processing capabilities. Subsequently, the system alters pixel values within the determined object boundaries to introduce visual noise, thus visually distinguishing selectable objects within the image.

Thus, one technical effect of the present disclosure is the enhanced visual distinction of selectable objects within digital images. This is achieved through the introduction of visual noise via the alteration of pixel values. The visual noise effectively distinguishes the selectable objects from the rest of the image, improving the efficiency and objective usability of a human-machine interface.

Another technical effect of the invention is the efficient use of computational resources. By providing a more intuitive interaction with the digital images, the invention reduces the need for users to perform multiple different searches or unnecessary selections to find the object of interest.

The process of accessing and processing digital images, determining object boundaries, and altering pixel values are all technical operations that require the use of technology. The resulting effects, namely the visual distinction of selectable objects and the efficient use of computational resources, are also technical as they directly relate to the improved functioning of a computer system.

With reference now to the Figures, example embodiments of the present disclosure will be discussed in further detail.

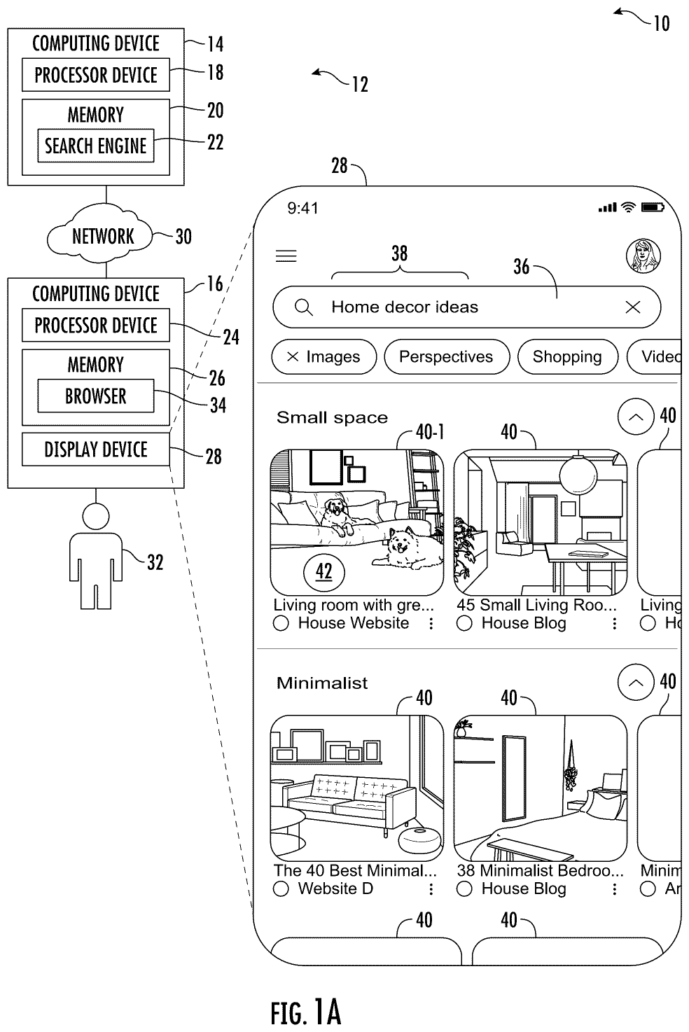

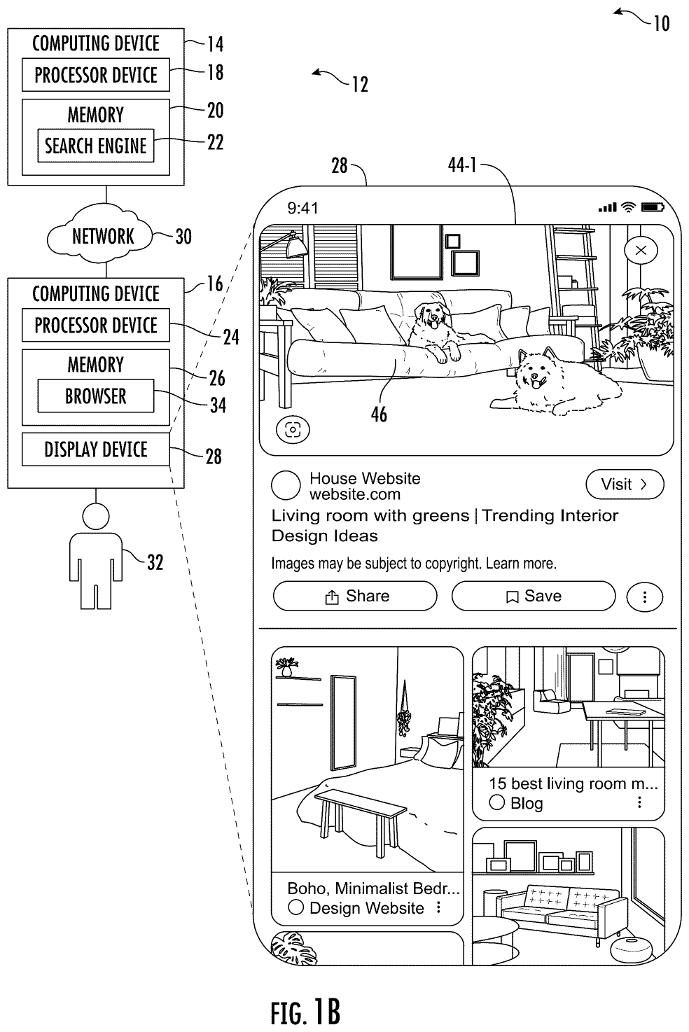

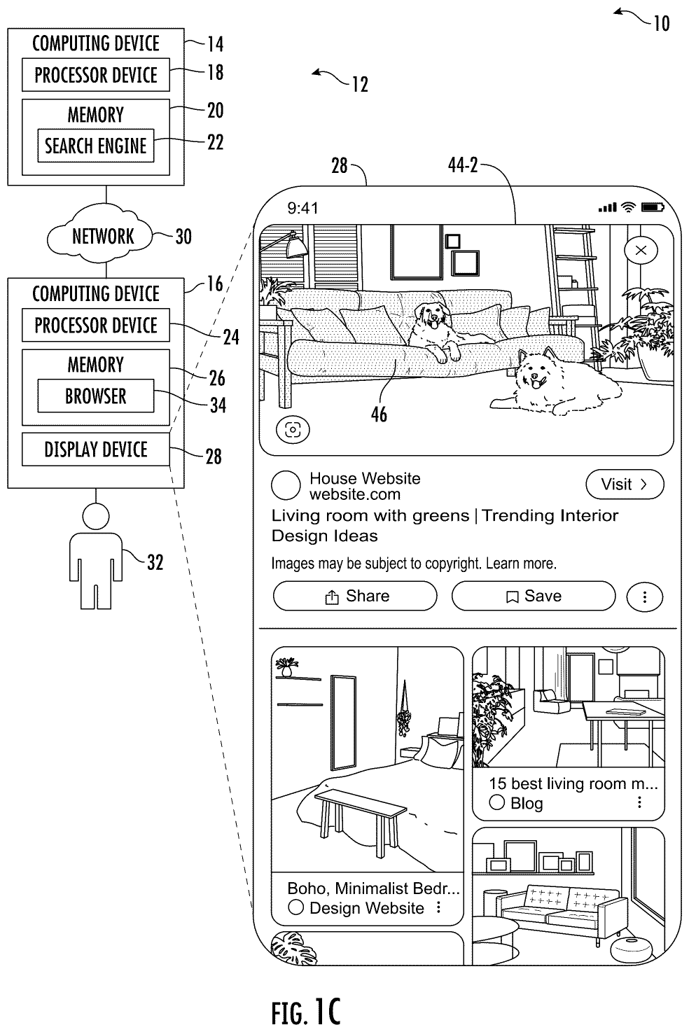

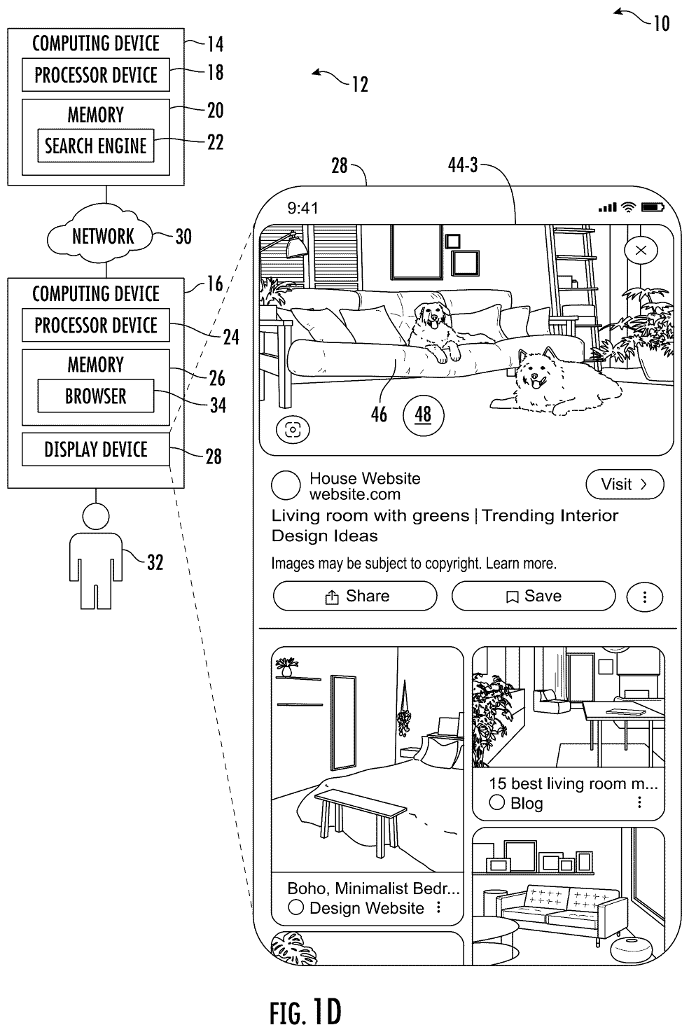

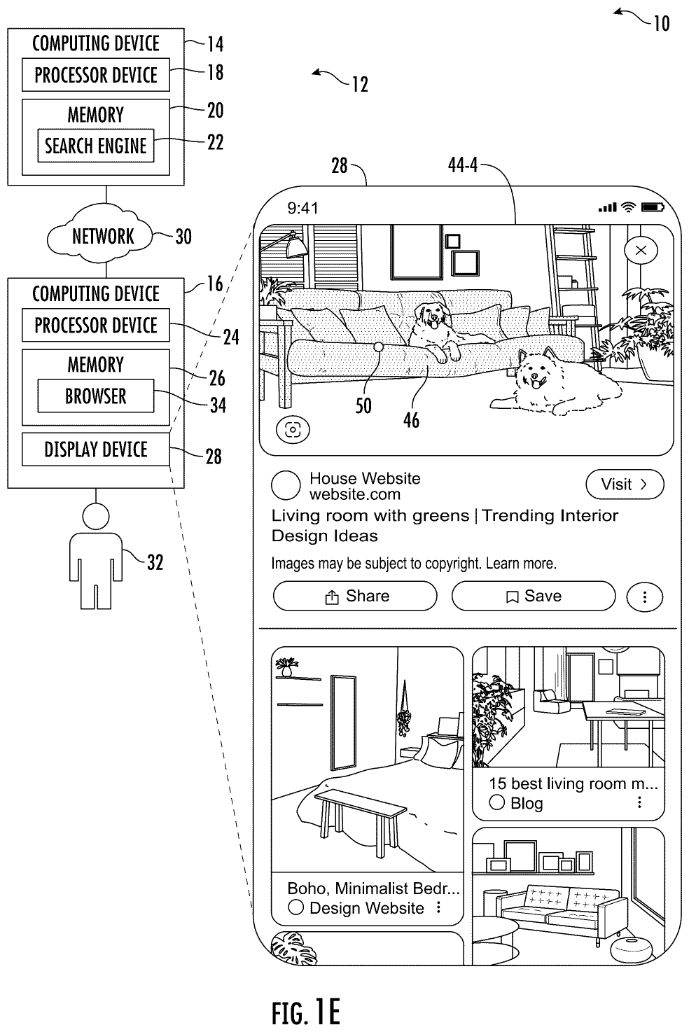

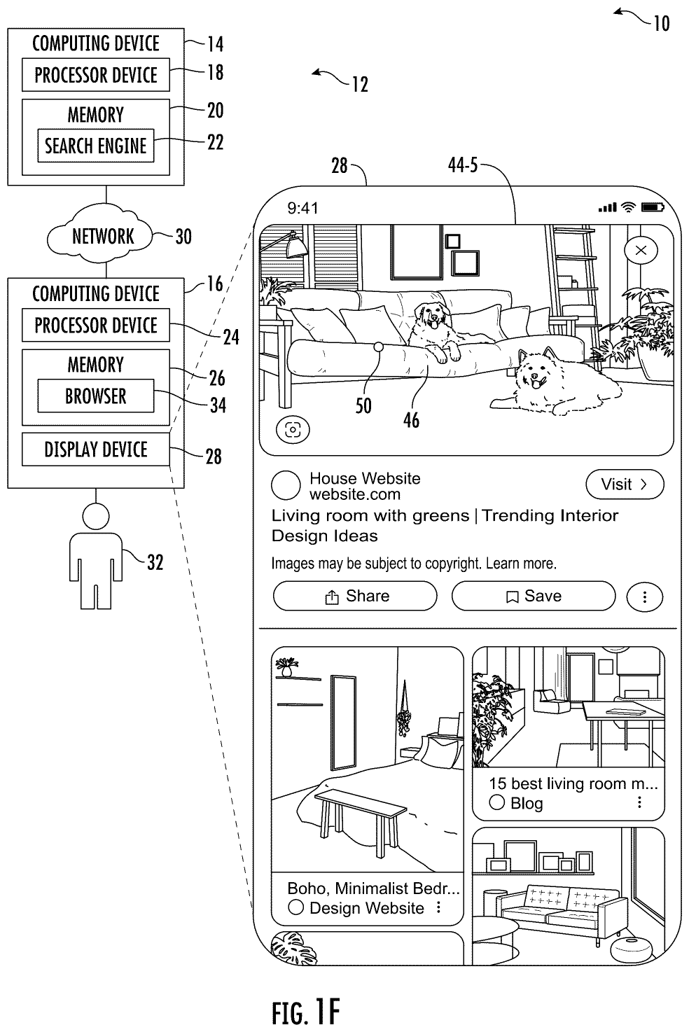

FIGS. 1A-1F illustrate a block diagram of an environment 10 at different points in time in which visually distinguishing selectable objects depicted in an image can be practiced according to some implementations. Referring first to FIG. 1A, the environment 10 includes a computing system 12 that includes a computing device 14 and a computing device 16. The computing device 14 includes a processor device 18 and a memory 20. The computing device 14 may comprise, for example, a computing device of a search engine provider. In this implementation, the computing device 14 implements a search engine 22 that can receive a search query that comprises one or more search terms, and conduct a search that may identify one or more images that satisfy the search terms.

The computing device 16 includes a processor device 24, a memory 26 and a display device 28. The computing device 16 may communicate with the computing device 14 via one or more networks 30, which may include any combination of wired and/or wireless networks. The computing device 16 and the computing device 14 may be in relatively close proximity to one another or may be thousands of miles from one another. The computing device 16 may comprise, for example, a smartphone, a computing tablet, a desktop or laptop computing device, or any other computing device capable of interacting with the computing device 14.

A user 32 may interact with the computing device 16 to initiate a web browser 34 in the memory 26. The user 32 may enter a destination of the search engine 22 in the web browser 34, such as a domain name that resolves to the search engine 22. In response, the search engine 22 provides for display on the display device 28 a search engine query field 36 via which the user 32 can enter one or more search terms to define a search query 38. The search query 38, in this example, comprises the words “Home decor ideas”. After entering the search query 38 into the search engine query field 36, the user 32 performs an action, such as selecting an enter key or the like, to cause the web browser 34 to send the search query 38 to the search engine 22.

The search engine 22 receives the search query 38 and performs a search based on the search query 38. The search engine 22 generates a plurality of search result thumbnail images 40-1, 40 (generally, search result thumbnail images 40). The search engine 22 provides for display the search result thumbnail images 40 by sending the search result thumbnail images 40 to the computing device 16 for presentation on the display device 28.

The user 32 may then select a particular search result thumbnail image 40, such as the search result thumbnail image 40-1, by contacting a location 42 of the search result thumbnail image 40-1. The computing device 14 determines the user input selection of the search result thumbnail image 40-1. For example, the computing device 16 may send a communication to the computing device 14 that the user 32 has selected the search result thumbnail image 40-1.

Referring now to FIG. 1B, in response to determining the user input selection of the search result thumbnail image 40-1, the computing device 14 may perform an object identification process on the search result thumbnail image 40-1, or on an image from which the search result thumbnail image 40-1 was derived, to identify a set of objects in the image. An object boundary is determined for each object in the set of objects. The computing device 14 may identify the set of objects in the image in any suitable manner, and may, in some implementations, process the image via one or more machine learned models, such as, by way of non-limiting example, one or more convolutional neural networks or the like, which have been trained to identify objects depicted in images.

In some implementations the computing device 14 may determine, based at least in part on the search query 38, a relevance of each object in the set of objects to the search query 38. Based on the relevance of each object, the computing device 14 may determine one or more objects in the set of objects that may be selectable by the user. In this example, it will be assumed that the computing device 14 determines that only a couch object 46 depicted in the image has sufficient relevance to be user selectable.

The computing device 14 provides for display an image 44-1, and sends the image 44-1 to the computing device 16 for presentation on the display device 28. The image 44-1 comprises a plurality of pixels, each of which has a corresponding pixel value that identifies an intensity of the corresponding pixel. The pixel value may, by way of non-limiting example, be a 8-bit, 16-bit, 24-bit or 30-bit value.

Referring now to FIG. 1C, in some implementations, the computing device 16 may provide for display an image 44-2 that implements a preliminary shimmer phase in which visual noise is introduced into the selectable objects, in this example, the couch object 46. The visual noise may be introduced, for example, by altering the pixel values of the pixels within the object boundary of the couch object 46 to introduce visual noise into the pixels within the object boundary. The term “visual noise” as used herein refers to altering a pixel value of a pixel such that the pixel, when depicted on the display device 28, appears differently from how the pixel appeared prior to the alteration of the pixel value. The visual noise may be introduced by altering pixel values of only some pixels within the object boundary to, for example, create a sense of graininess, or by altering the pixel values of all the pixels within the object boundary. Because the visual noise is introduced for only a period of time, sometimes referred to as a preliminary shimmer period of time, after which time the visual noise is removed by restoring the original pixel values, the area within the object boundary is visually distinguished from other objects in the image 44 during the preliminary shimmer phase. The preliminary shimmer period of time may comprise, by way of non-limiting example, 500 milliseconds (MS), 1 second, 2 seconds, or any other suitable or desirable brief period of time. The preliminary shimmer phase may occur automatically subsequent to the initial presentation of the image 44-1 as illustrated in FIG. 1B, such as two or three seconds subsequent to presentation of the image 44-1 as illustrated in FIG. 1B, or in response to a user input, such as a selection of a location of the image 44-1.

The term “provide for display” as used herein refers to the computing device 14 generating suitable information that instructs the computing device 16 to present imagery on the display device 28. In some implementations, the computing device 14 may generate a package that, when processed by the computing device 16, automatically causes the presentation of the imagery on the display device 28 as illustrated in the Figures. For example, the computing device 14 may generate an animation that, when processed by the computing device 16 initially presents the image 44-1 as illustrated in FIG. 1B, and then automatically causes the shimmer as illustrated in the image 44-2 illustrated in FIG. 1C for the preliminary shimmer period of time. In other implementations, the computing device 14 may generate suitable instructions sufficient for the computing device 16 to generate and present the imagery on the display device 28 as illustrated in the Figures. Moreover, while for purposes of illustration certain processing may be described as occurring on one of the computing devices 14, 16, in other implementations such processing could be performed on the other of the computing devices 14, 16. For example, in some implementations the computing device 14 may implement the appropriate processing necessary to cause the shimmer of an object, and provide information to the computing device 16 to generate imagery that depicts the shimmer, and in other implementations the computing device 16 may implement the appropriate processing necessary to cause the shimmer of an object.

Referring now to FIG. 1D, subsequent to the preliminary shimmer period of time, the computing device 14 may provide for display an image 44-3 without any visual noise. In one implementation, the user 32 may then select the image 44-3, such as by, for example, contacting an arbitrary location 48 of the image 44-3. Referring now to FIG. 1E, the computing device 14 determines the user input selection of the image 44-3, and provides for display an image 44-4 that implements a shimmer phase. The computing device 14 determines the object boundary of the couch object 46, and alters the pixel values of pixels within the object boundary to introduce visual noise into the pixels for a shimmer period of time. The computing device 14 also generates a user selectable icon 50 for display in association with the couch object 46. The computing device 16 presents the image 44-4 on the display device 28.

The term “for display in association with” refers to locating the user selectable icon 50 on, within the object boundary of, or in proximity to the couch object 46, such that it is apparent, in conjunction with the shimmer phase, that the user selectable icon 50 corresponds to the couch object 46. The shimmer period of time can be, for example, 500 ms, 1 second, 2 seconds, or any other suitable or desirable brief period of time. The user selectable icon 50 may be presented concurrently while the couch object 46 is being shimmered, may be presented prior to the couch object 46 being shimmered, or may be presented immediately subsequent to the couch object 46 being shimmered.

Referring now to FIG. 1F, subsequent to the shimmer phase, the computing device 14 provides for display an image 44-5 that removes the visual noise from the pixel values within the object boundary of the couch object 46, leaving the user selectable icon 50. The computing device 16 presents the image 44-5 on the display device 28. It is noted that, while the images 44-1-44-5 are discussed as separate images, in practice, they are modifications of the same image over time. In practice, in some implementations the images 44-1-44-5 may be implemented as individual images that are successively presented on the display device 28. In other implementations, the image 44-1 may be initially presented on the display device 28 and only the pixel values of the pixels that change over the sequence of images 44-1-44-5 may be altered to cause the changes illustrated in the images 44-1-44-5.

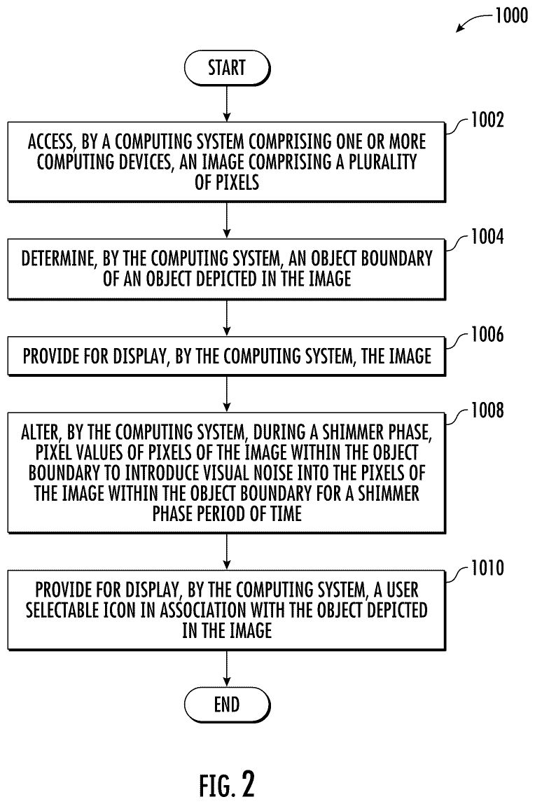

FIG. 2 depicts a flow chart diagram of an example method 1000 to visually distinguish selectable objects in an image according to example embodiments of the present disclosure. Although FIG. 2 depicts steps performed in a particular order for purposes of illustration and discussion, the methods of the present disclosure are not limited to the particularly illustrated order or arrangement. The various steps of the method 1000 can be omitted, rearranged, combined, and/or adapted in various ways without deviating from the scope of the present disclosure.

At step 1002, the computing system 12 may access the image 44-1 comprising a plurality of pixels. At step 1004, the computing system 12 may determine an object boundary of the couch object 46 depicted in the image 44-1. At step 1006, the computing system 12 may provide the image 44-1 for display. At step 1008, the computing system 12 may alter, during a shimmer phase, pixel values of pixels of the image 44-4 within the object boundary to introduce visual noise into the pixels within the object boundary for a shimmer phase period of time. At step 1010, the computing system 12 may provide for display the user selectable icon 50 in association with the couch object 46 depicted in the image 44-4.

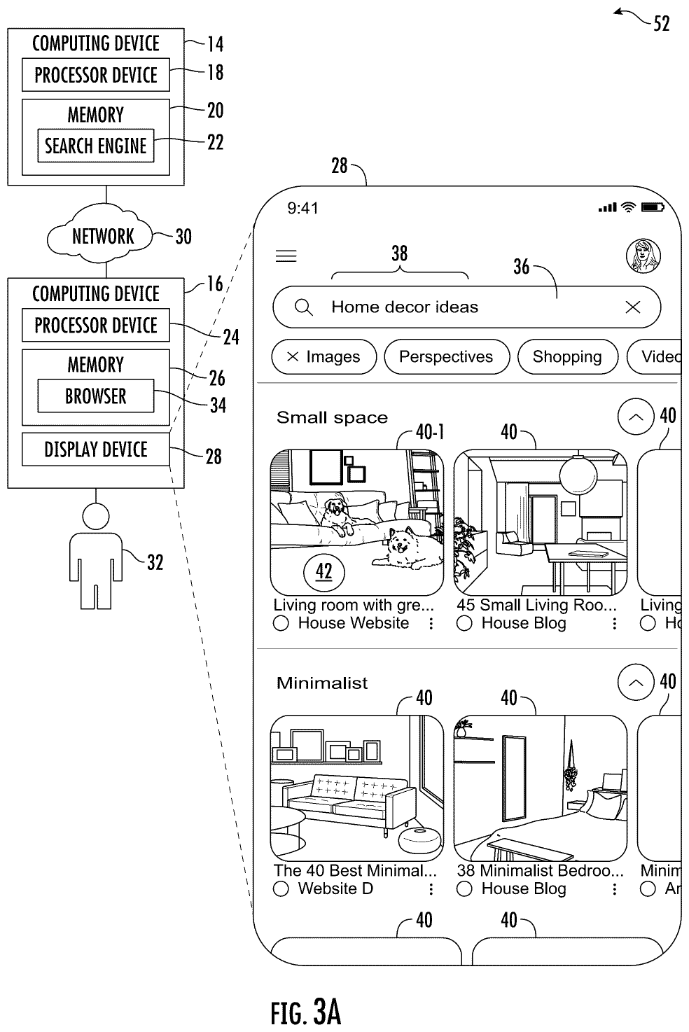

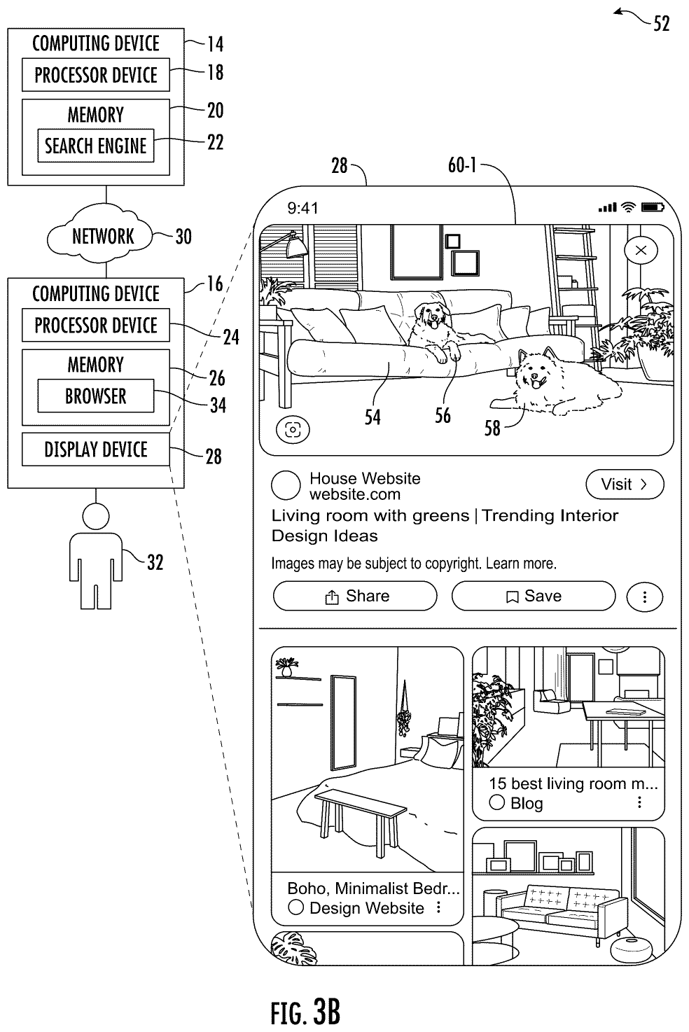

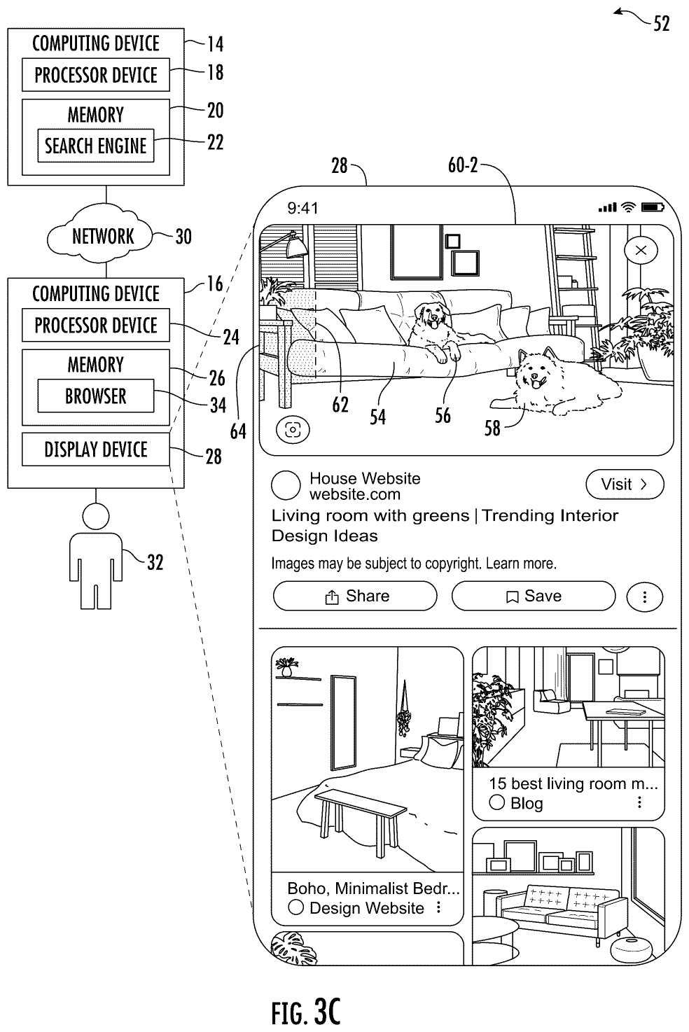

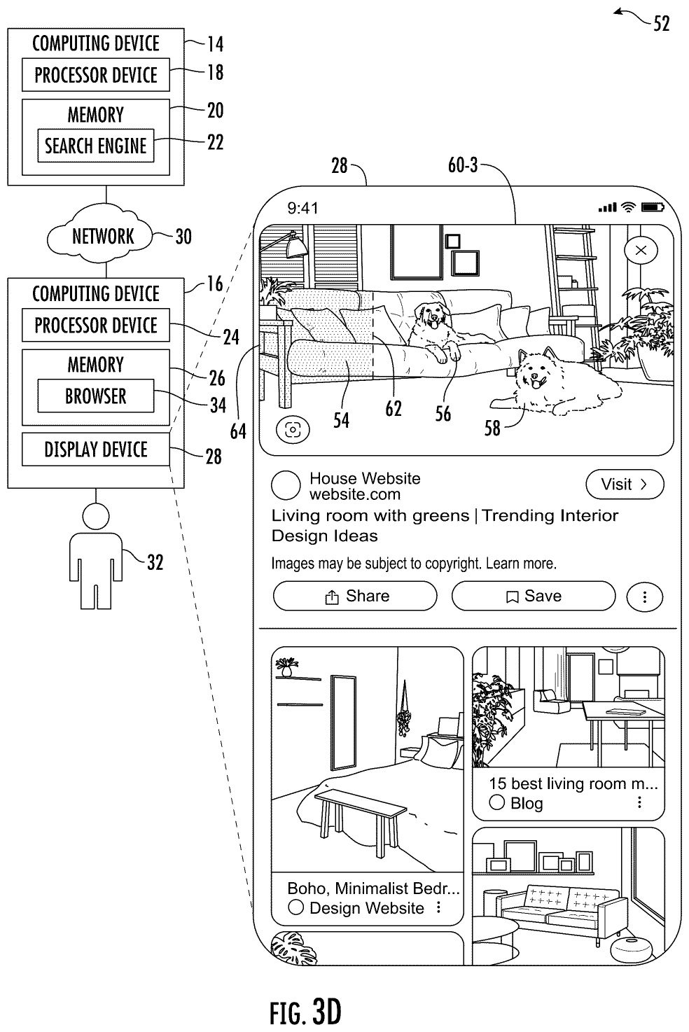

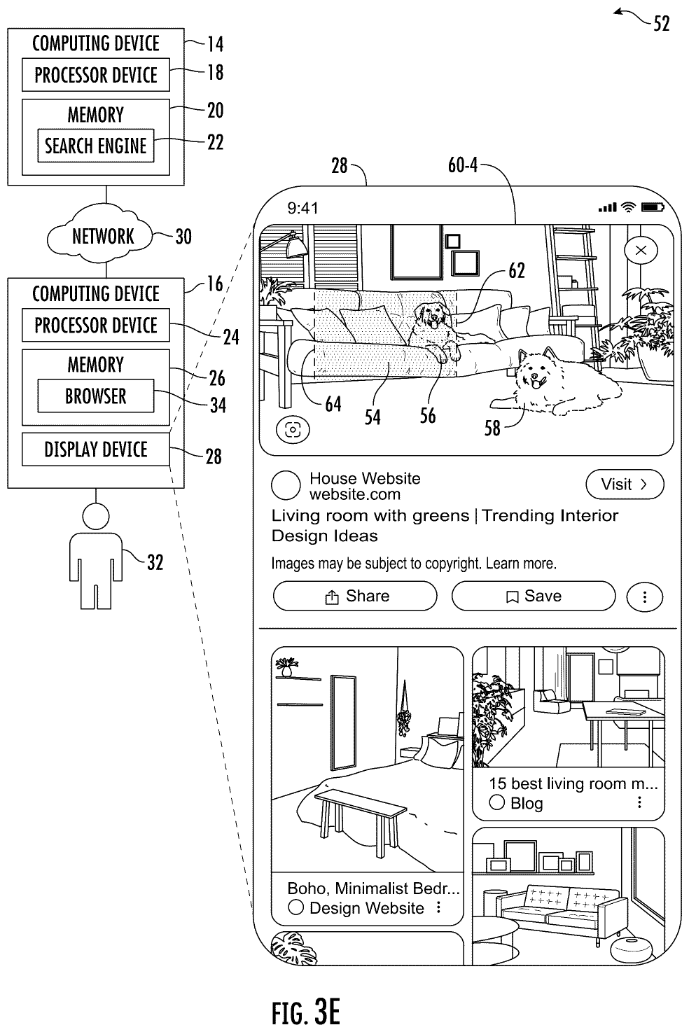

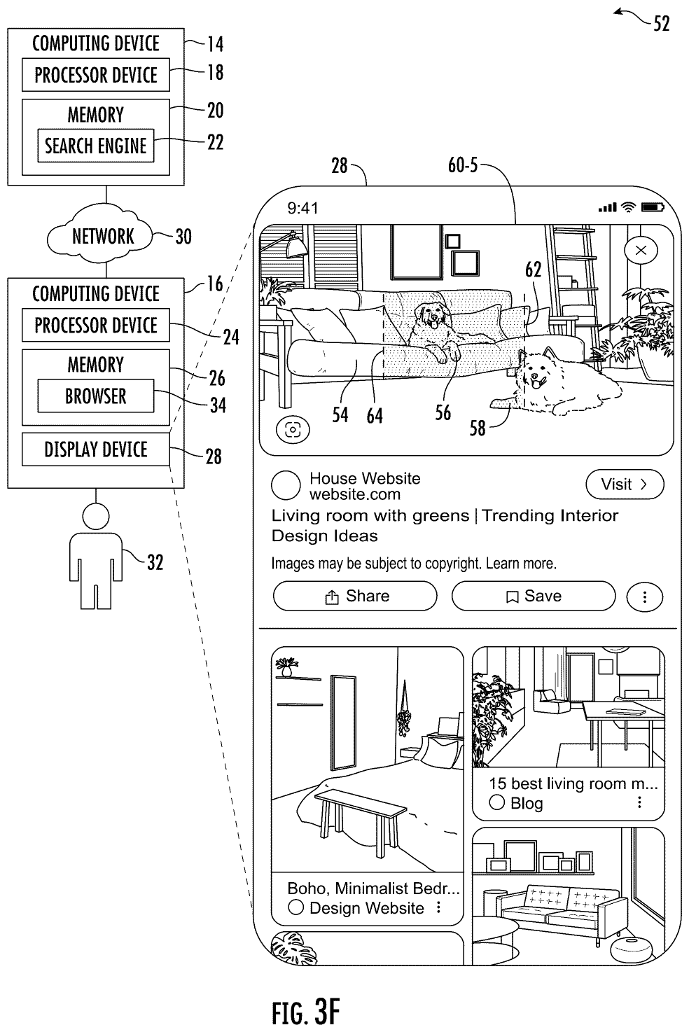

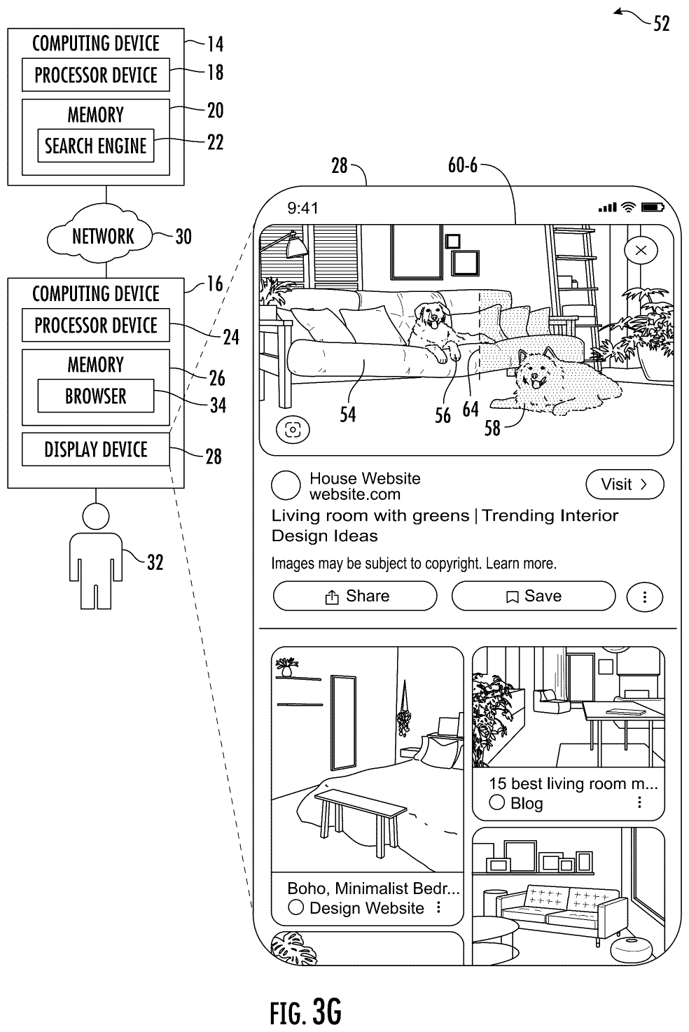

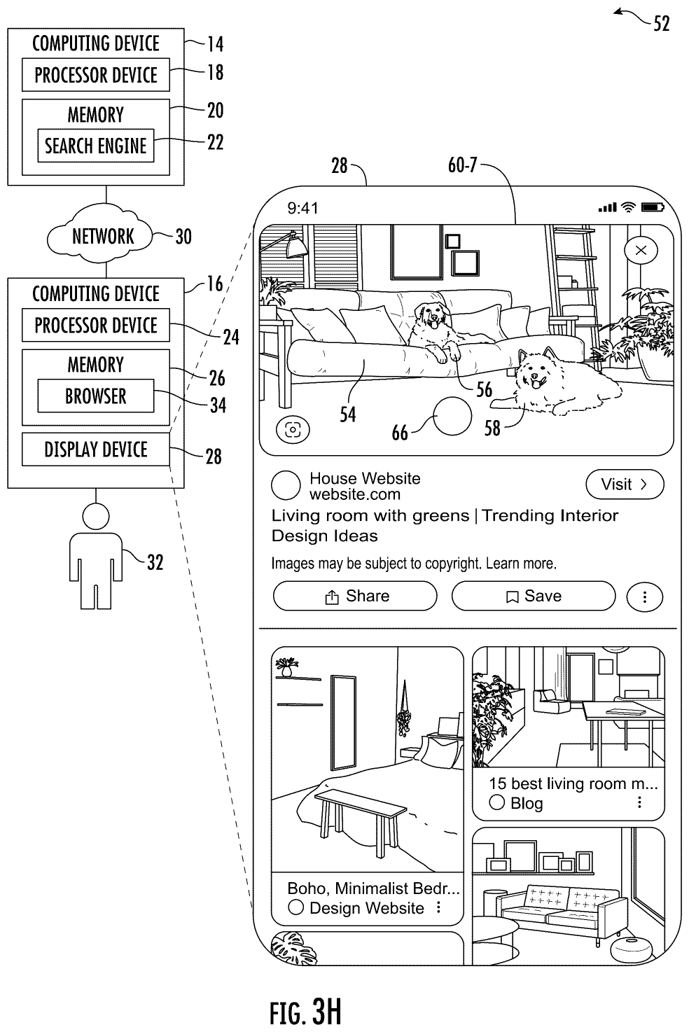

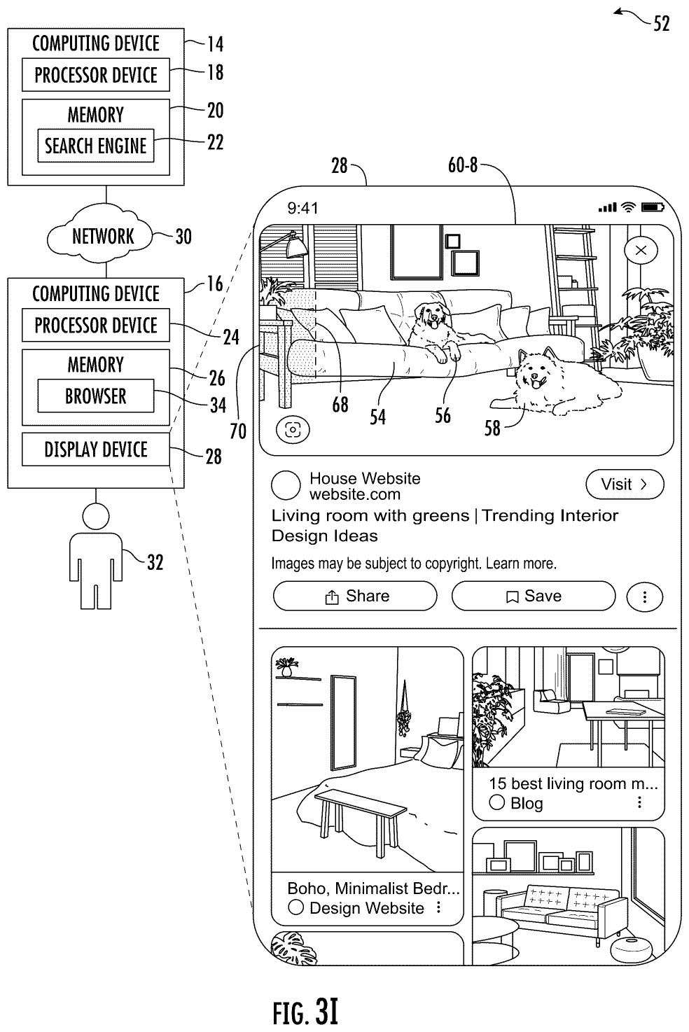

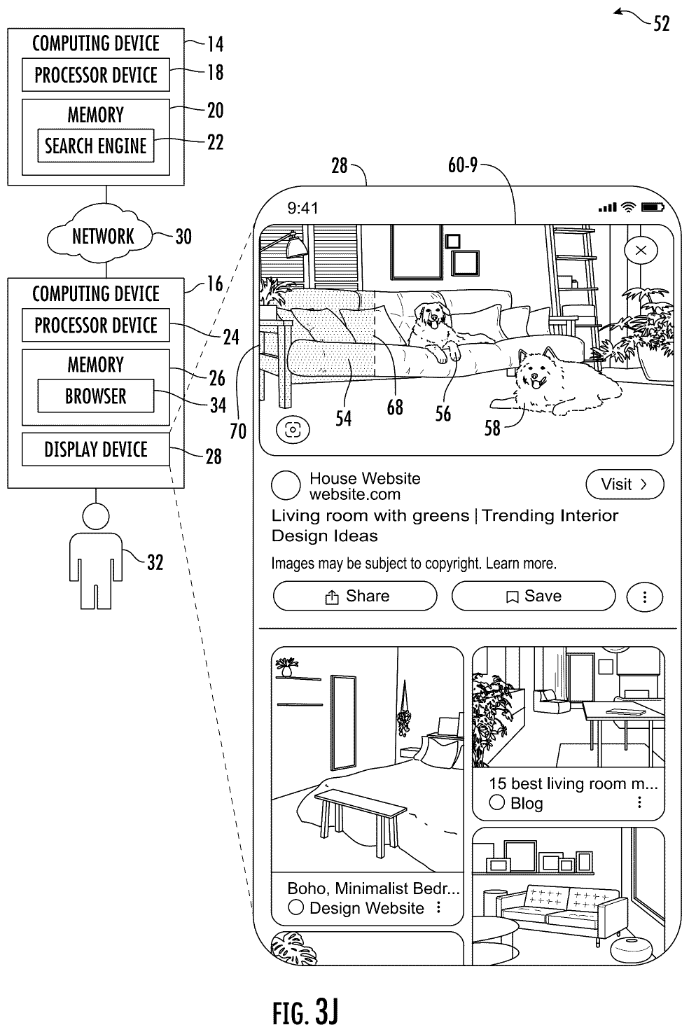

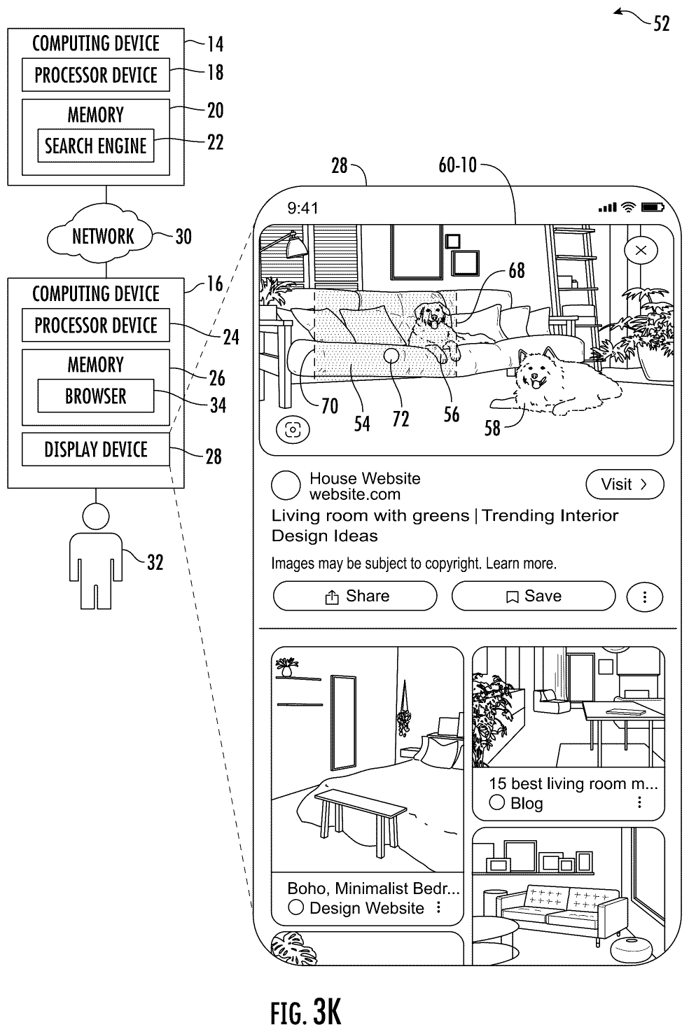

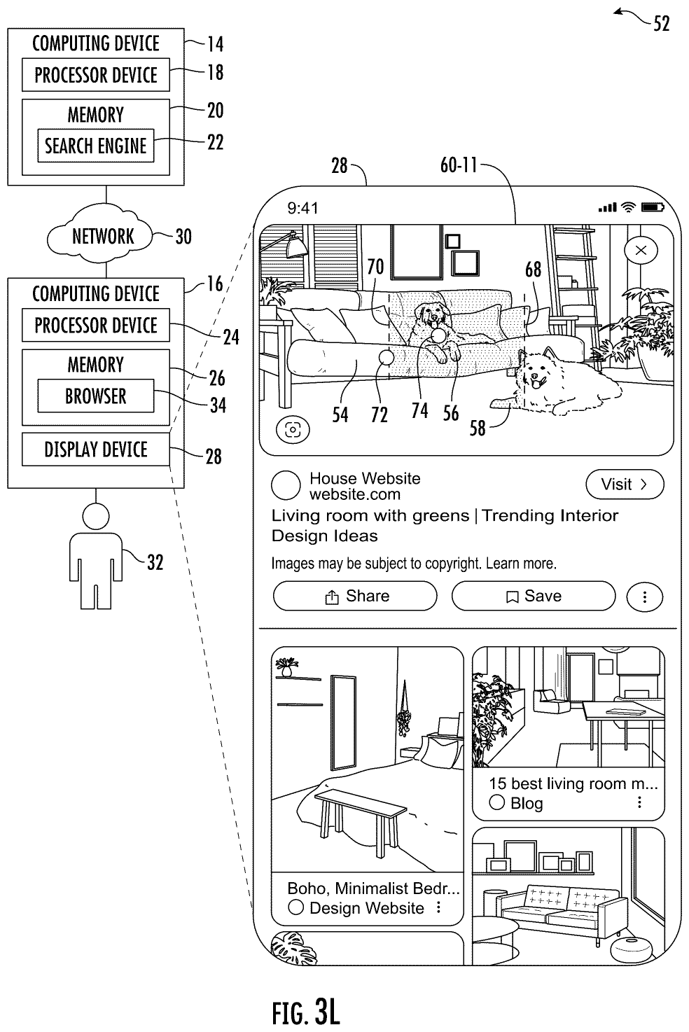

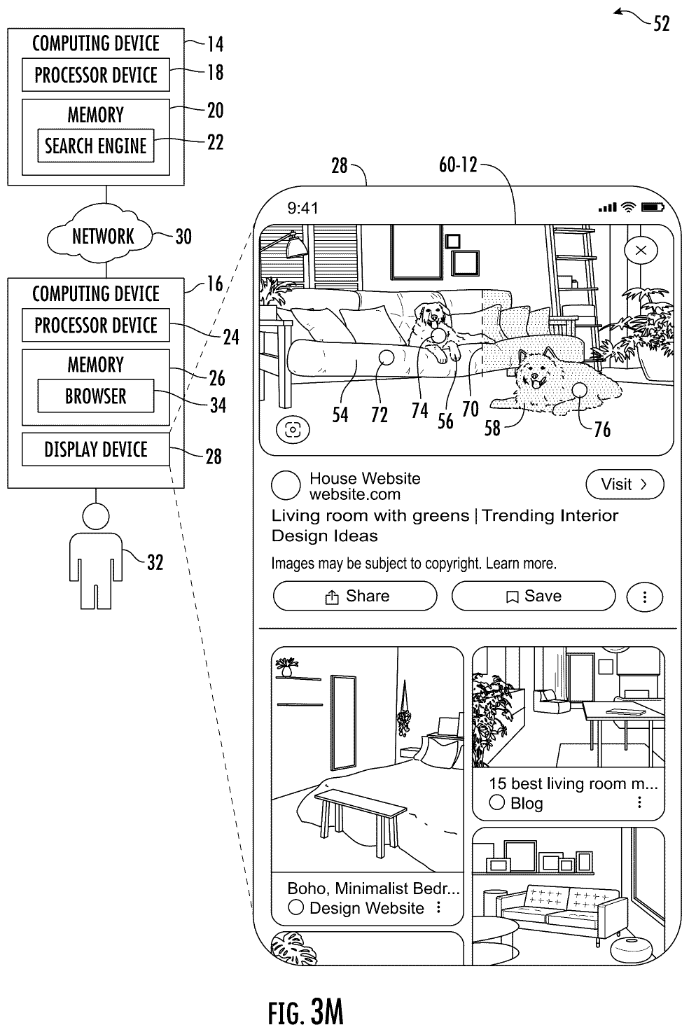

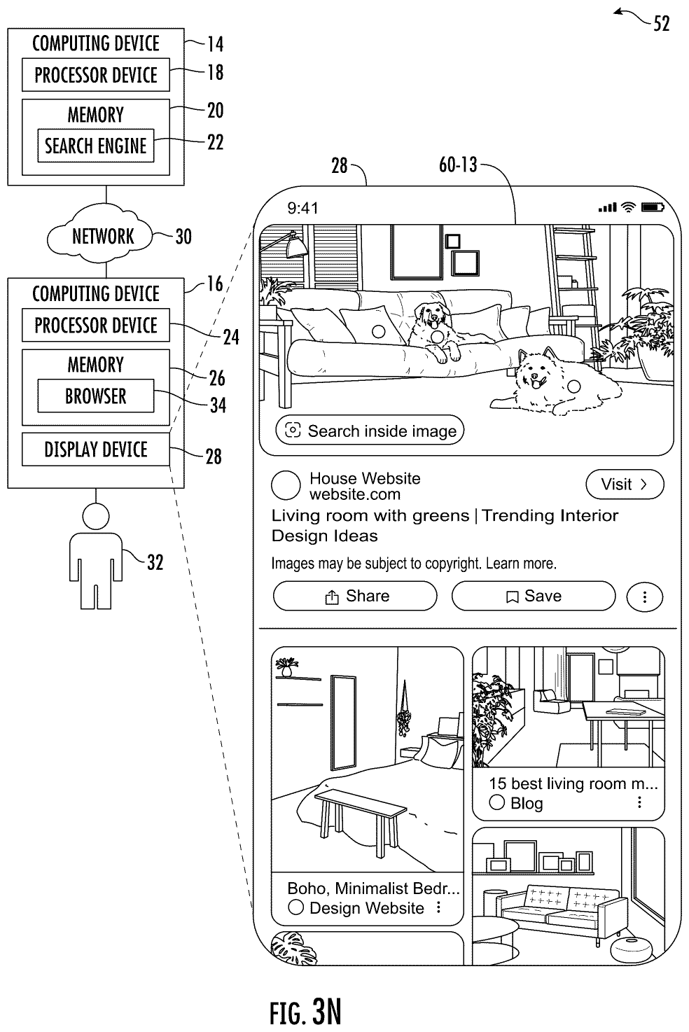

FIGS. 3A-3N illustrate a block diagram of an environment 52 at different points in time in which visually distinguishing selectable objects in an image can be practiced according to additional implementations. The environment 52 is substantially similar to the environment 10 illustrated above except as otherwise discussed herein. Referring first to FIG. 3A, the user 32 again enters the search query 38 comprising the words “Home decor ideas” into the search engine query field 36. After entering the search query 38, the user 32 performs an action, such as selecting an enter key or the like, to cause the web browser 34 to send the search query 38 to the search engine 22.

The search engine 22 receives the search query 38 and performs a search based on the search query 38. The search engine 22 generates the plurality of search result thumbnail images 40. The search engine 22 provides for display the search result thumbnail images 40 by sending the search result thumbnail images 40 to the computing device 16.

The user 32 selects the search result thumbnail image 40-1 by contacting the location 42 of the search result thumbnail image 40-1. The computing device 14 determines the user input selection of the search result thumbnail image 40-1. For example, the computing device 16 may send a communication to the computing device 14 indicating that the user 32 has selected the search result thumbnail image 40-1.

Referring now to FIG. 3B, in response to determining the user input selection of the search result thumbnail image 40-1, the computing device 14 performs the object identification process on the search result thumbnail image 40-1, or on an image from which the search result thumbnail image 40-1 was derived to identify a set of objects in the image. An object boundary is determined for each object in the set of objects. Again, the computing device 14 may identify the set of objects in the image in any suitable manner, and may, in some implementations, process the image via one or more machine learned models, such as, by way of non-limiting example, one or more convolutional neural networks or the like, which has been trained to identify objects depicted in images.

In some implementations the computing device 14 may determine, based at least in part on the search query 38, a relevance of each object in the set of objects to the search query 38. Based on the relevance of each object, the computing device 14 may determine one or more objects in the set of objects that may be selectable by the user. In this example, it will be assumed that the computing device 14 determines that three objects in the image will be user selectable, a couch object 54, a dog object 56 and another dog object 58.

The computing device 14 provides for display an image 60-1, and sends the image 60-1 to the computing device 16 for presentation on the display device 28. The image 60-1 comprises a plurality of pixels, each of which has a corresponding pixel value that identifies an intensity of the corresponding pixel.

Referring now to FIG. 3C, in some implementations, the computing device 16 may provide for display an image 60-2 that implements a preliminary shimmer phase in which visual noise is introduced into the selectable objects, in this example, the couch object 46 and the dog objects 56, 58. Again, the visual noise may be introduced, for example, by altering the pixel values of the pixels within the object boundary of the couch object 46 to introduce visual noise into the pixels within the object boundary. In this implementation, however, the computing device 16 causes the shimmer to move across the image 60-2. In particular, the computing system 12 alters the pixel values of pixels of the image 60-2 within each object boundary of the plurality of object boundaries asynchronously to form a leading visual noise edge 62 and a trailing visual noise edge 64 that move across the image 60-2 in a direction, in this case from left to right. However, it is noted that the direction can be any direction, such as right to left, top to bottom, bottom to top, or diagonally across the image 60-2.

Referring now to FIG. 3D, the computing system 12 causes the leading visual noise edge 62 to move in the left to right direction by introducing the visual noise into adjacent pixels within each object boundary as illustrated in an image 60-3.

Referring now to FIG. 3E, the computing system 12 causes the leading visual noise edge 62 to move in the left to right direction by introducing the visual noise into adjacent pixels within each object boundary, and causes the trailing visual noise edge 64 to move in the left to right direction by removing the visual noise from adjacent pixels of the image in the left to right direction as illustrated in an image 60-4.

Referring now to FIG. 3F, the computing system 12 causes the leading visual noise edge 62 to move in the left to right direction by introducing the visual noise into adjacent pixels within each object boundary, and causes the trailing visual noise edge 64 to move in the left to right direction by removing the visual noise from adjacent pixels of the image in the left to right direction as illustrated in an image 60-5.

Referring still to FIG. 3F, it can be seen that the leading visual noise edge 62 is located in the same location for multiple different objects (e.g., objects 54, 56, 58). Having one consistently timed shimmer for all selectable objects is one possible approach. Another possible approach of the present disclosure is for each object to have its own individual shimmer. The individual shimmers for multiple objects can be simultaneous, overlapping, or non-overlapping in time. For example, a shimmer for object 54 could begin first and then, while the shimmer for object 54 is halfway completed then the shimmer for object 58 could begin. Thus, in some examples, multiple different shimmer effects for multiple different objects may have different, respective leading and trailing edge locations and/or timings.

Referring now to FIG. 3G, the leading visual noise edge stops as it leaves the object boundaries of the objects farthest to the right in an image 60-6, and the trailing visual noise edge 64 has moved farther in the left to right direction.

Referring now to FIG. 3H, the preliminary shimmer has completed, as illustrated in an image 60-7. In implementations that utilize a preliminary shimmer, such as illustrated in FIGS. 60-1-60-7, the preliminary shimmer may comprise any suitable period of time, such as, by way of non-limiting example, 500 ms, 1 second, 2 seconds, or the like. The preliminary shimmer phase may occur automatically subsequent to the initial presentation of the image 60-1 as illustrated in FIG. 3B, such as two or three seconds subsequent to presentation of the image 60-1 as illustrated in FIG. 3B, or in response to a user input, such as a selection of a location of the image 60-1. It is noted that, while the images 60-1-60-7 are discussed as separate images, in practice, they are modifications of the same image over time.

In this example, the user 32 selects the image 60-7, such as by, for example, contacting an arbitrary location 66 of the image 60-7. Referring now to FIG. 3I, the computing device 14 determines the user input selection of the image 60-7, and provides for display an image 60-8 that implements another shimmer phase. The computing device 14 determines the object boundary of the couch object 54 and the dog objects 56, 58 and again implements a moving shimmer across the image 60-8 similar or identical to the shimmer described above with regard to FIGS. 3C-3G. The image 60-8 illustrates a leading visual noise edge 68 and a trailing visual noise edge 70. FIG. 3J illustrates the leading visual noise edge 68 and the trailing visual noise edge 70 moving across an image 60-9. FIG. 3K illustrates the leading visual noise edge 68 and the trailing visual noise edge 70 moving across an image 60-10 and the concurrent presentation of a user selectable icon 72 that is presented in association with the couch object 54 concurrently while the couch object 54 is being shimmered. FIG. 3L illustrates the leading visual noise edge 68 and the trailing visual noise edge 70 moving across an image 60-11 and the concurrent presentation of a user selectable icon 74 that is presented in association with the dog object 56 concurrently while the dog object 56 is being shimmered.

Referring still to FIG. 3F, it can be seen that the leading visual noise edge 68 is located in the same location for multiple different objects (e.g., objects 54, 56, 58). Having one consistently timed shimmer for all selectable objects is one possible approach. Another possible approach of the present disclosure is for each object to have its own individual shimmer. The individual shimmers for multiple objects can be simultaneous, overlapping, or non-overlapping in time. For example, a shimmer for object 54 could begin first and then, while the shimmer for object 54 is halfway completed then the shimmer for object 58 could begin. Thus, in some examples, multiple different shimmer effects for multiple different objects may have different, respective leading and trailing edge locations and/or timings.

Referring not to FIG. 3M, FIG. 3M illustrates the leading visual noise edge 68 and the trailing visual noise edge 70 moving across an image 60-12 and the concurrent presentation of a user selectable icon 76 that is presented in association with the dog object 58 concurrently while the dog object 58 is being shimmered. FIG. 3N illustrates an image 60-13 subsequent to the shimmer phase, leaving the user selectable icons 72, 74 and 76. It is noted that, while the images 60-8-60-13 are discussed as separate images, in practice, they are modifications of the same image over time.

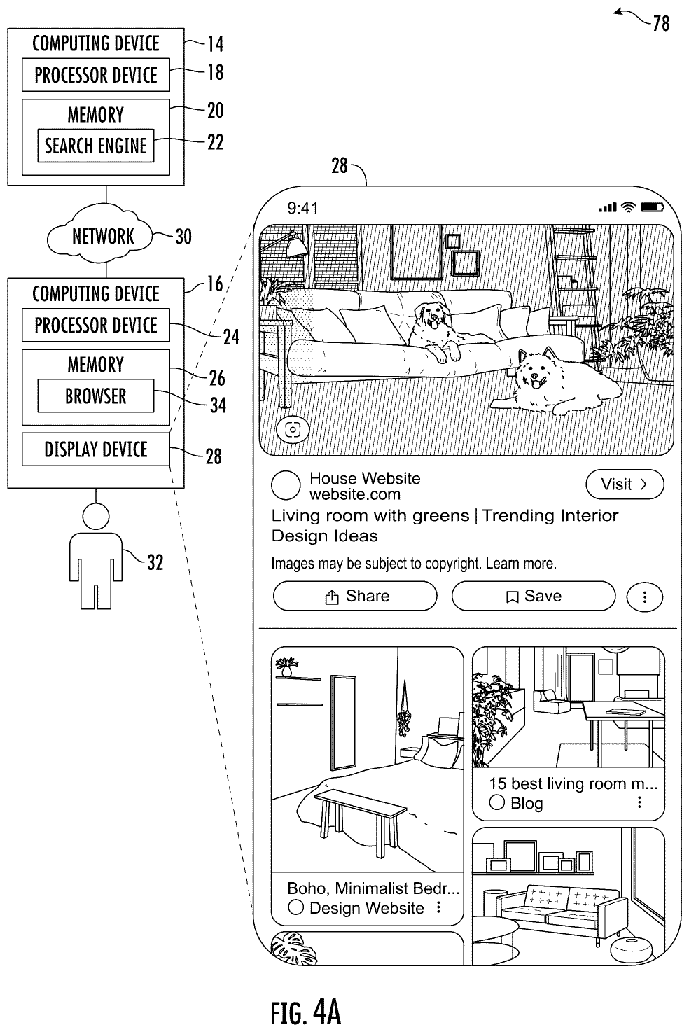

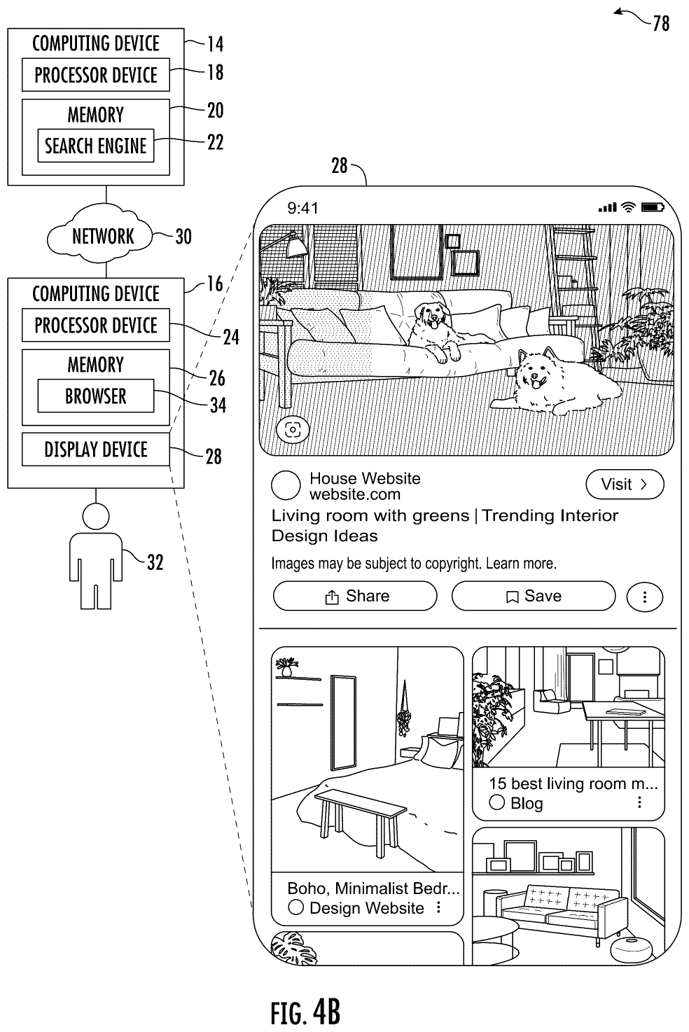

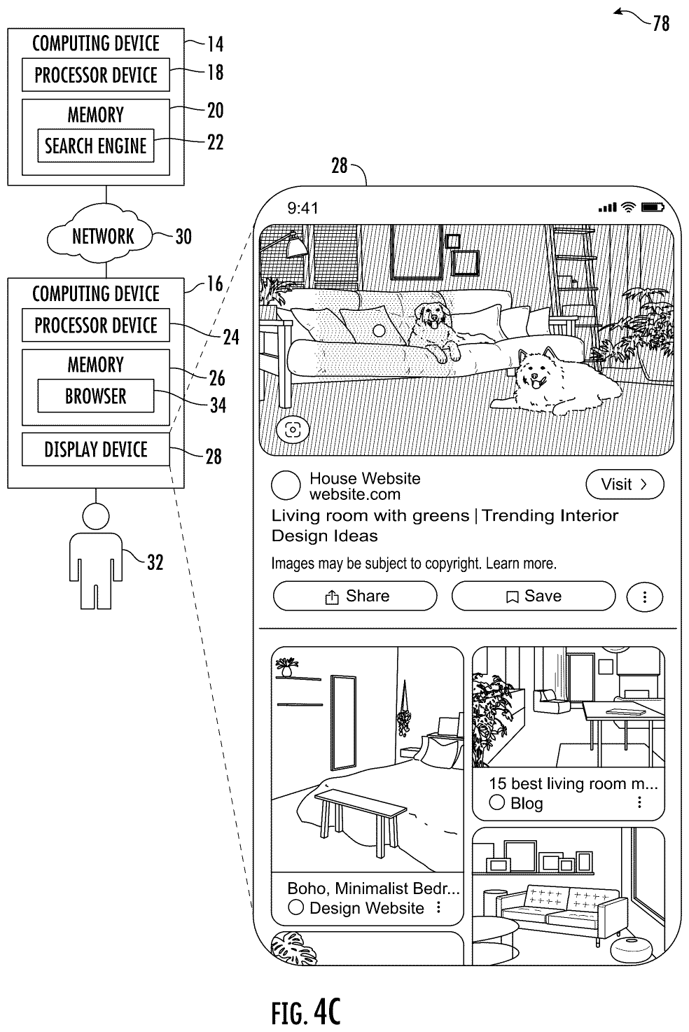

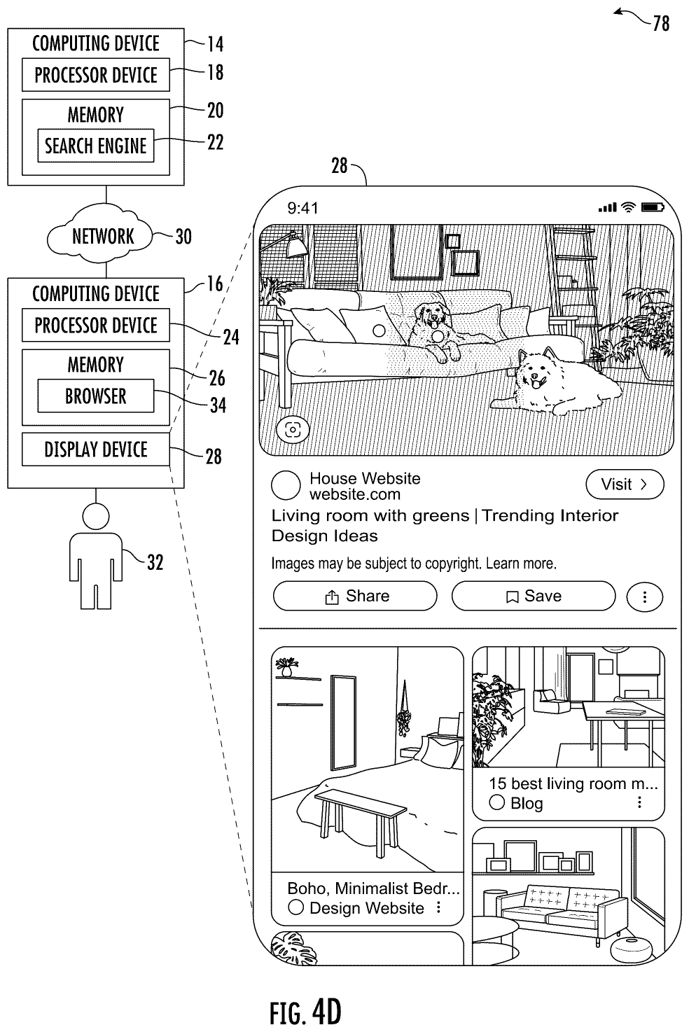

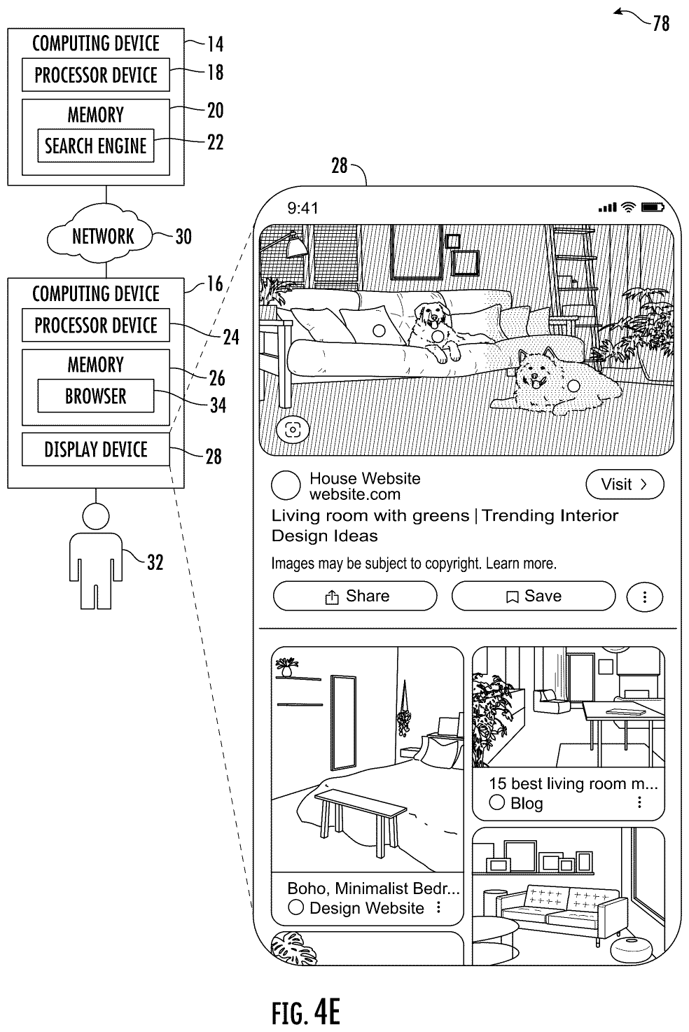

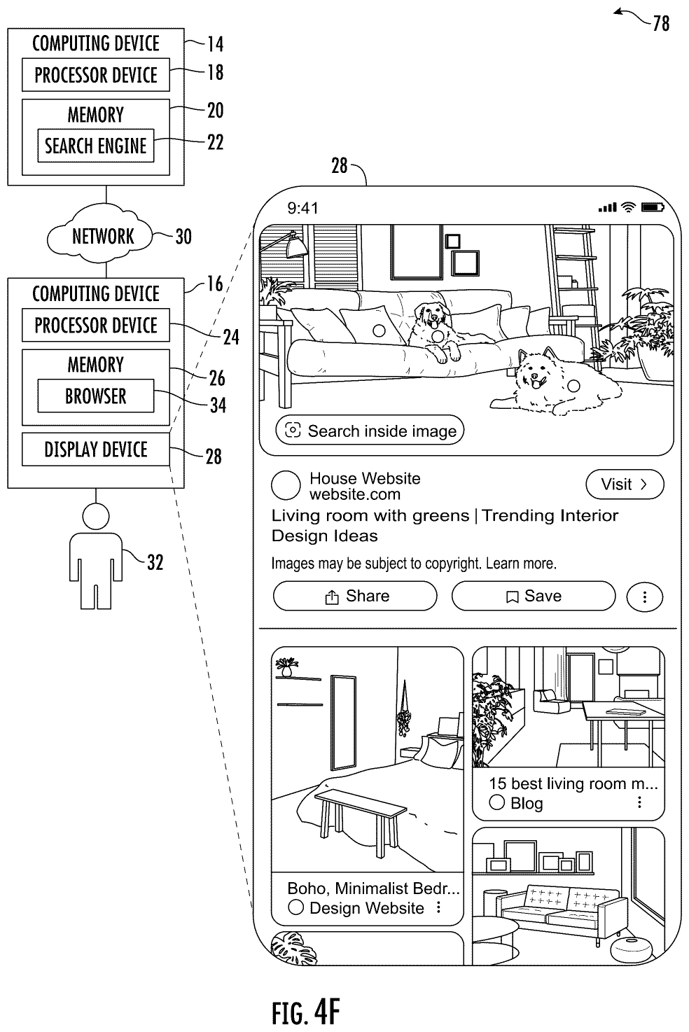

FIGS. 4A-4F illustrate a block diagram of an environment 78 at different points in time in which visually distinguishing selectable objects in an image can be practiced according to additional implementations. The environment 78 is substantially similar to the environments 10, 52 illustrated above except as otherwise discussed herein. In this implementation during the shimmer phase, and during the preliminary shimmer phase if a preliminary shimmer phase is utilized, the pixel values of the pixels that are not within an object boundary are altered to further visually distinguish the selectable objects from the non-selectable objects. In one implementation, the pixel values of the pixels that are not within an object boundary are altered to reduce an intensity of each pixel on the image that is not within an object boundary. In some implementations, the pixel values of the pixels that are not within an object boundary may be altered concurrently at the beginning of the shimmer phase while the shimmer moves across the selectable objects, as illustrated above with regard to FIGS. 3A-3N. After the shimmer phase ends, the pixel values of the pixels that are not within an object boundary may be restored to their original values.

In an alternative embodiment, the present disclosure provides a method that, rather than introducing a shimmer phase to visually distinguish selectable objects, employs a highlighting technique or keeps the selectable objects visually unamended while non-selectable portions of the screen are darkened or otherwise visually demoted. This ensures the selectable object(s) stand out, thereby making them more visually identifiable to a user.

Specifically, the computing system, comprising one or more computing devices, accesses an image made up of multiple pixels. As in the previous embodiment, an object boundary of an object depicted in the image is determined. The image is then provided for display. However, instead of altering pixel values within the object boundary to introduce a shimmer effect, in this embodiment, the computing system may visually highlight the object within the boundary during a highlight phase. The visual highlighting could be achieved by altering pixel values to change the color or brightness of the pixels within the object boundary, or by adding a visible border or outline around the object boundary. In another variation of this embodiment, the selectable objects within the image may remain visually unamended.

Alternatively or additionally, the computing system alters the pixel values of the portions of the image that are outside the object boundary, i.e., the non-selectable portions. This could be done by darkening the non-selectable portions, reducing their saturation, or applying a visual effect that makes them appear blurred or less distinct. By doing this, the non-selectable portions of the image are visually demoted, which makes the selectable objects stand out and more easily identifiable by the user.

The highlighting and/or darkening effects used in these embodiments can be temporary, similar to the shimmer phase in the previous embodiment. For example, the computing system may introduce the highlighting or darkening effects for a specific period of time to catch the user's attention. Once this period ends, the original pixel values could be restored, allowing the user to continue interacting with the image in its original form.

Moreover, similar to the previous embodiment, a user-selectable icon may be provided in association with the object depicted in the image after the highlight or demotion phase completes. This serves as an additional visual cue that the object is selectable. The provision of multiple object boundaries within an image is also possible in this embodiment, meaning that multiple objects within an image can be visually distinguished and made selectable. For example, one possible embodiment may correspond to the visual effect illustrated in FIGS. 4A-F, but without the shimmer effect.

As such, this alternative embodiment provides an intuitive and efficient way of identifying selectable objects within an image. By visually highlighting the selectable objects and/or visually demoting the non-selectable portions, user interaction with digital images is enhanced, and the common issue of users struggling to understand which objects within an image are selectable for obtaining further information is addressed.

The technology discussed herein may make reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Distributed components can operate sequentially or in parallel.

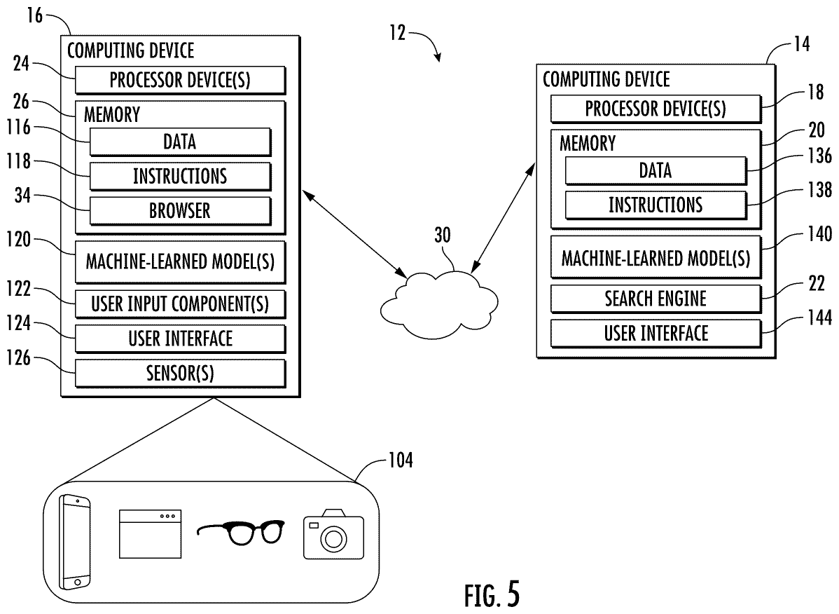

FIG. 5 depicts a block diagram of the computing system 12 that implements visually distinguishing selectable objects in an image according to example embodiments of the present disclosure. The system 12 includes the computing device 16 and the computing device 14 that are communicatively coupled over the network 30.

The computing device 16 can include any type of computing device, such as, for example, a personal computing device (e.g., laptop or desktop), a mobile computing device (e.g., smartphone or tablet), a gaming console or controller, a wearable computing device, an embedded computing device, or any other type of computing device.

The computing device 16 includes one or more processor devices 24 and the memory 26. The one or more processor devices 24 can be any suitable processing device (e.g., a processor core, a microprocessor, an ASIC, a FPGA, a controller, a microcontroller, etc.) and can be one processor device or a plurality of processor devices that are operatively connected. The memory 26 can include one or more non-transitory computer-readable storage mediums, such as RAM, ROM, EEPROM, EPROM, flash memory devices, magnetic disks, etc., and combinations thereof. The memory 26 can store data 116 and instructions 118 which are executed by the processor device 24 to cause the computing device 16 to perform operations.

In some implementations, the computing device 16 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. The machine-learned models 120 may, for example, be trained to detect objects in images.

In some implementations, the one or more machine-learned models 120 can be received from the computing device 14 over the network 30, stored in the memory 26, and then used or otherwise implemented by the one or more processor devices 24. In some implementations, the computing device 16 can implement multiple parallel instances of a single machine-learned model 120 (e.g., to perform parallel machine-learned model processing across multiple instances of input data and/or detected features).

More particularly, the one or more machine-learned models 120 may include one or more detection models, one or more classification models, one or more segmentation models, one or more augmentation models, one or more generative models, one or more natural language processing models, one or more optical character recognition models, and/or one or more other machine-learned models. The one or more machine-learned models 120 can include one or more transformer models. The one or more machine-learned models 120 may include one or more neural radiance field models, one or more diffusion models, and/or one or more autoregressive language models.

The one or more machine-learned models 120 may be utilized to detect one or more object features. The detected object features may be classified and/or embedded. The classification and/or the embedding may then be utilized to perform a search to determine one or more search results. Alternatively and/or additionally, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models 120 can process image data, text data, audio data, and/or latent encoding data to generate output data that can include image data, text data, audio data, and/or latent encoding data. The one or more machine-learned models 120 may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask based segmentation).

Additionally or alternatively, one or more machine-learned models 140 can be included in or otherwise stored and implemented by the computing device 14 that communicates with the computing device 16 according to a client-server relationship. For example, the machine-learned models 140 can be implemented by the computing device 14 as a portion of a web service (e.g., a viewfinder service, a visual search service, an image processing service, an ambient computing service, and/or an overlay application service). Thus, one or more models 120 can be stored and implemented at the computing device 16 and/or one or more models 140 can be stored and implemented at the computing device 14.

The computing device 16 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the computing device 16 can store and/or provide one or more user interfaces 124, which may be associated with one or more applications. The one or more user interfaces 124 can be configured to receive inputs and/or provide data for display (e.g., image data, text data, audio data, one or more user interface elements, an augmented-reality experience, a virtual reality experience, and/or other data for display). The user interfaces 124 may be associated with one or more other computing systems (e.g., the computing device 14). The user interfaces 124 can include a viewfinder interface, a search interface, a generative model interface, a social media interface, and/or a media content gallery interface.

The computing device 16 may include and/or receive data from one or more sensors 126. The one or more sensors 126 may be housed in a housing component that houses the one or more processor devices 24, the memory 26, and/or one or more hardware components, which may store, and/or cause to perform, one or more software packets. The one or more sensors 126 can include one or more image sensors (e.g., a camera), one or more lidar sensors, one or more audio sensors (e.g., a microphone), one or more inertial sensors (e.g., inertial measurement unit), one or more biological sensors (e.g., a heart rate sensor, a pulse sensor, a retinal sensor, and/or a fingerprint sensor), one or more infrared sensors, one or more location sensors (e.g., GPS), one or more touch sensors (e.g., a conductive touch sensor and/or a mechanical touch sensor), and/or one or more other sensors. The one or more sensors can be utilized to obtain data associated with a user's environment (e.g., an image of a user's environment, a recording of the environment, and/or the location of the user).

The computing device 16 may include, and/or be part of, a user computing device 104. The user computing device 104 may include a mobile computing device (e.g., a smartphone or tablet), a desktop computer, a laptop computer, a smart wearable, and/or a smart appliance. Additionally and/or alternatively, the computing device 14 may obtain from, and/or generate data with, the one or more one or more user computing devices 104. For example, a camera of a smartphone may be utilized to capture image data descriptive of the environment, and/or an overlay application of the user computing device 104 can be utilized to track and/or process the data being provided to the user. Similarly, one or more sensors associated with a smart wearable may be utilized to obtain data about a user and/or about a user's environment (e.g., image data can be obtained with a camera housed in a user's smart glasses). Additionally and/or alternatively, the data may be obtained and uploaded from other user devices that may be specialized for data obtainment or generation.

The computing device 14 includes one or more processor devices 18 and a memory 20. The one or more processor devices 18 can be any suitable processing device (e.g., a processor core, a microprocessor, an ASIC, a FPGA, a controller, a microcontroller, etc.) and can be one processor device or a plurality of processor devices that are operatively connected. The memory 20 can include one or more non-transitory computer-readable storage mediums, such as RAM, ROM, EEPROM, EPROM, flash memory devices, magnetic disks, etc., and combinations thereof. The memory 20 can store data 136 and instructions 138 which are executed by the processor device 18 to cause the computing device 14 to perform operations.

In some implementations, the computing device 14 includes or is otherwise implemented by one or more server computing devices. In instances in which the computing device 14 includes plural server computing devices, such server computing devices can operate according to sequential computing architectures, parallel computing architectures, or some combination thereof.

As described above, the computing device 14 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIG. 9B.

Additionally and/or alternatively, the computing device 14 can include and/or be communicatively connected with a search engine 22 that may be utilized to crawl one or more databases (and/or resources). The search engine 22 can process data from the computing device 16 and/or the computing device 14 to determine one or more search results associated with the input data. The search engine 22 may perform term based search, label based search, Boolean based searches, image search, embedding based search (e.g., nearest neighbor search), multimodal search, and/or one or more other search techniques.

The computing device 14 may store and/or provide one or more user interfaces 144 for obtaining input data and/or providing output data to one or more users. The one or more user interfaces 144 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

The network 30 can be any type of communications network, such as a local area network (e.g., intranet), wide area network (e.g., Internet), or some combination thereof and can include any number of wired or wireless links. In general, communication over the network 30 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

The computing device 14 may include a number of applications (e.g., applications 1 through N). Each application may include its own respective machine learning library and machine-learned model(s). For example, each application can include a machine-learned model. Example applications include a text messaging application, an email application, a dictation application, a virtual keyboard application, a browser application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

The computing device 16 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing system 12.

The central intelligence layer can communicate with a central device data layer. The central device data layer can be a centralized repository of data for the computing system 12. The central device data layer may communicate with a number of other components of the computing device, such as, for example, one or more sensors, a context manager, a device state component, and/or additional components. In some implementations, the central device data layer can communicate with each device component using an API (e.g., a private API).

The examples set forth herein represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A method for providing a visual search interface with improved efficiency, comprising:
accessing, by a computing system comprising one or more computing devices, an image comprising a plurality of pixels;
determining, by the computing system, an object boundary of an object depicted in the image;
providing for display, by the computing system, the image;
altering, by the computing system, during a shimmer phase, pixel values of pixels within the object boundary to introduce visual noise into the pixels of the image within the object boundary for a shimmer phase period of time; and
providing for display, by the computing system, a user selectable icon in association with the object depicted in the image.

2. The method of claim 1, further comprising:
subsequent to the shimmer phase period of time, altering, by the computing system, the pixel values of the pixels within the object boundary to remove the visual noise from the image.

3. The method of claim 1 further comprising:
altering, by the computing system, during a preliminary shimmer phase that occurs prior to the shimmer phase, the pixel values of the pixels within the object boundary to introduce visual noise into the pixels within the object boundary of the image; and
subsequent to the preliminary shimmer phase and prior to the shimmer phase, altering, by the computing system, the pixel values of the pixels within the object boundary to remove the visual noise from the image.

4. The method of claim 1 further wherein:
determining, by the computing system, the object boundary of the object depicted in the image comprises determining the object boundaries of a plurality of objects depicted in the image, including the object;
altering, by the computing system, during the shimmer phase, the pixel values of pixels within the object boundary to introduce the visual noise into the pixels of the image within the object boundary for the shimmer period of time further comprises altering, by the computing system, during the shimmer phase, the pixel values of pixels of the image within each object boundary of the plurality of object boundaries to introduce the visual noise into the pixels within the plurality of object boundaries for the shimmer phase period of time; and
providing for display, by the computing system, the user selectable icon in association with the object on the image further comprises providing for display, by the computing system, a plurality of user selectable icons, each user selectable icon being provided for display in association with corresponding ones of the plurality of objects depicted in the image.

5. The method of claim 4, further comprising:
determining, by the computing system, a user input selection of the image; and wherein
altering, by the computing system, during the shimmer phase, the pixel values of pixels within each object boundary of the plurality of object boundaries to introduce the visual noise into the pixels of the image within the plurality of object boundaries for the shimmer phase period of time is in response to the user input selection.

6. The method of claim 4, further comprising:
altering, by the computing system, during a preliminary shimmer phase that occurs prior to the shimmer phase the pixel values of pixels of the image within each object boundary of the plurality of object boundaries to introduce visual noise into the pixels within the plurality of object boundaries for a preliminary shimmer phase period of time.

7. The method of claim 4, wherein providing for display, by the computing system, the plurality of user selectable icons, each user selectable icon being provided for display in association with corresponding ones of the plurality of objects on the image further comprises:
providing for display, by the computing system, the plurality of user selectable icons, each user selectable icon being provided for display in association with corresponding ones of the plurality of objects concurrently while the pixel values within the object boundary of the corresponding object are being altered to introduce the visual noise.

8. The method of claim 4 wherein the shimmer phase period of time is less than two seconds.

9. The method of claim 4, further comprising:
prior to providing for display, by the computing system on the display device, the image:
receiving, by the computing system, a search query;
performing, by the computing system, a search based on the search query;
generating, by the computing system, a plurality of search result thumbnail images, one of the plurality of search result thumbnail images corresponding to the image; and
providing for display, by the computing system, at least some of the search result thumbnail images, including the search result thumbnail image that corresponds to the image.

10. The method of claim 9 further comprising:
subsequent to providing for display the at least some of the search result thumbnail images and prior to providing for display the image on the display device, determining, by the computing system, a user input selection of the search result thumbnail image that corresponds to the image.

11. The method of claim 9, further comprising:
identifying, by the computing system, a set of objects in the image;
determining, by the computing system, a relevance of each object in the set of objects based at least in part on the search query; and
selecting, by the computing system, the plurality of objects from the set of objects based on the relevance of each object.

12. The method of claim 4, wherein altering, by the computing system, during the shimmer phase, the pixel values of pixels within each object boundary of the plurality of object boundaries to introduce the visual noise into the pixels of the image within the plurality of object boundaries for the shimmer phase period of time further comprises altering, by the computing system, the pixel values of pixels of the image within each object boundary of the plurality of object boundaries asynchronously to form a leading visual noise edge and a trailing visual noise edge that move across the image in a direction, the leading visual noise edge being caused to move in the direction by introducing the visual noise into adjacent pixels of the image within each object boundary in the direction and the trailing visual noise edge being formed by continuously removing the visual noise from adjacent pixels of the image in the direction.

13. The method of claim 4, further comprising:
during the shimmer phase, altering the pixel values of each pixel on the image that is not within an object boundary to reduce an intensity of each pixel on the image that is not within an object boundary.

14. The method of claim 13, wherein the pixel values of each pixel on the image that is not within an object boundary are reduced concurrently.

15. A computing system, comprising:
one or more computing devices operable to:
access an image comprising a plurality of pixels;
determine an object boundary of an object depicted in the image;
provide the image for display;
alter, during a shimmer phase, pixel values of pixels of the image within the object boundary to introduce visual noise into the pixels within the object boundary for a shimmer phase period of time; and
provide for display a user selectable icon in association with the object depicted in the image.

16. The computing system of claim 15, wherein the one or more computing devices are further operable to:
alter, during a preliminary shimmer phase that occurs prior to the shimmer phase, the pixel values of the pixels of the image within the object boundary to introduce visual noise into the pixels within the object boundary; and
subsequent to the preliminary shimmer phase and prior to the shimmer phase, alter the pixel values of the pixels within the object boundary to remove the visual noise.

17. The computing system of claim 15, wherein:
to determine the object boundary of the object depicted in the image, the one or more computing devices are further operable to determine the object boundaries of a plurality of objects depicted in the image, including the object;
to alter, during the shimmer phase, the pixel values of pixels of the image within the object boundary to introduce the visual noise into the pixels within the object boundary for the shimmer period of time, the one or more computing devices are further operable to alter, during the shimmer phase, the pixel values of pixels of the image within each object boundary of the plurality of object boundaries to introduce the visual noise into the pixels within the plurality of object boundaries for the shimmer phase period of time; and
to provide for display the user selectable icon in association with the object, the one or more computing devices are further operable to provide for display a plurality of user selectable icons, each user selectable icon being provided for display in association with corresponding ones of the plurality of objects depicted in the image.

18. The computing system of claim 15, wherein the computing system consists of a mobile computing device.

19. A non-transitory computer-readable storage medium that includes executable instructions operable to cause one or more computing devices to:
access an image comprising a plurality of pixels;
determine an object boundary of an object depicted in the image;
provide the image for display;
alter, during a shimmer phase, pixel values of pixels of the image within the object boundary to introduce visual noise into the pixels within the object boundary for a shimmer phase period of time; and
provide for display a user selectable icon in association with the object depicted in the image.

20. The non-transitory computer-readable storage medium of claim 19, wherein:
to determine the object boundary of the object depicted in the image, the instructions further cause the one or more computing devices to determine the object boundaries of a plurality of objects depicted in the image, including the object;
to alter, during the shimmer phase, the pixel values of pixels of the image within the object boundary to introduce the visual noise into the pixels within the object boundary for the shimmer period of time, the instructions further cause the one or more computing devices to alter, during the shimmer phase, the pixel values of pixels of the image within each object boundary of the plurality of object boundaries to introduce the visual noise into the pixels within the plurality of object boundaries for the shimmer phase period of time; and
to provide for display the user selectable icon in association with the object, the instructions further cause the one or more computing devices to provide for display a plurality of user selectable icons, each user selectable icon being provided for display in association with corresponding ones of the plurality of objects depicted in the image.
